(19) United States
(12) Patent Application Publication
(10) Pub. No.: US 2008/0077945 A1
(43) Pub. Date: Mar. 27, 2008

(54) SYSTEM AND METHOD FOR PROVIDING A GRAPHICAL USER INTERFACE FOR DISPARATE APPLICATIONS

(76) Inventor: Ramasubramaniyam Sethuraman, Greensboro, NC (US)

Correspondence Address: SMITH MOORE LLP, P.O. BOX 21927, GREENSBORO, NC, 27420, US

(21) Appl. No.: 11/847,922

(22) Filed: Aug. 30, 2007

Related U.S. Application Data
(60) Provisional application No. 60/824,106, filed on Aug. 31, 2006.

(51) Int. Cl. G06F 9/54

(52) U.S. Cl. 719/329

(57) ABSTRACT

A system for providing a graphical user interface that enables a user to send data to and view data from multiple, disparate applications. The system includes a display organizer that presents the user with a view of widgets on a screen. The widgets display data from the disparate applications and data input by the user that is intended for the disparate applications. A data display array (DDA), which is an updatable data file for the widgets, comprises parameter information relating to how the widgets are displayed. Data sent to the disparate applications and returned from the disparate applications is parsed and then updated in the DDA. An interpreter transacts data between the user and the disparate applications via an adapter that communicates with the disparate applications and the interpreter in a format that is understood by both.

This application claims the benefit of provisional application No. 60/824,106, filed Aug. 31, 2006.

The present invention is directed towards a technology platform that enables communication with multiple layers of disparate applications via a user-friendly interface.

### BRIEF SUMMARY OF THE INVENTION

A system for providing a graphical user interface is provided that enables sending data to and viewing data from disparate applications via the graphical user interface comprising: a display organizer capable of presenting a view of at least one widget, the at least one widget being configured to display data from at least one of the disparate applications and being configured to accept data input that is intended for the at least one of the disparate applications; a data display array that is an updatable data file for the at least one widget and comprises parameter information relating to how the at least one widget is displayed via the display organizer; a rules parser engine comprising rules for parsing the data input via the display organizer, the rules parser engine being capable of transmitting parsed data to the data display array; an interpreter that is capable of building a query with the data input that is intended for the at least one of the disparate applications and querying the at least one of the disparate applications for data to be reported via the display organizer; a reverse parser comprising rules for parsing data from the interpreter that is intended to be reported and transmitting the parsed data to the data display array; and an adapter that is capable of communicating data to and from the at least one of the disparate applications and the interpreter in a format that is understood by the at least one of the disparate applications and the interpreter. The at least one widget may be configured to display data from multiple ones of the disparate applications and accept data input that is intended for multiple ones the disparate applications.

The at least one of the disparate applications may be a software application or a manual applications. The parameter information in the data display array may further relate to information selected from the group consisting of user identity information, user display preferences information, and printing properties information. Data in a first at least one widget is capable of being linked to data in a second at least one widget such that a change to the data in the first at least one widget may effect a change of the data in the second at least one widget.

The system further comprises a login module that is capable of validating a user identity by storing in a first file a username and a path file name indicating where the user's password is stored and storing in a second file an encrypted version of the user's password such that a hash value associated with the encrypted version of the user's password may be changed on a random or periodic basis.

The system further comprises a screenwriter module that is capable of reading data from the data display array relating to the view that is presented and transmitting the data to the display organizer. The data that the screenwriter module transmits to the data display array includes information about the at least one widget selected from the group consisting of widget existence, widget alignment, and widget colors. The rules in the rules parser engine may be specific to a single user or a group of users.

The system further comprises at least one master thread that is capable of determining a transaction processing order for data that is transmitted from the data display array to the interpreter, the master thread determining such transaction processing order based on information selected from the group consisting of the user identity, and the type of action to be taken regarding the data. Worker threads are also provided, which are capable of determining the transaction processing order for the master thread. The master thread is capable of posting a query to the at least one of the disparate applications and transmitting a response to the query from the at least one of the disparate applications to the interpreter.

The rules in the reverse parser provide intelligence to parse data, the intelligence being selected from the group consisting of data oriented intelligence, and screen oriented intelligence. The adapter further comprises an adapter interface for the at least one of the disparate applications, the adapter interface being capable of packaging data in the format that is understood by the at least one of the disparate applications and the interpreter.

A method for providing a graphical user interface that enables sending data to and viewing data from disparate applications via the graphical user interface is provided, the method comprising the steps of: presenting a view of at least one widget, the at least one widget being configured to display data from at least one of the disparate applications and accept data input that is intended for the at least one of the disparate applications; parsing data input and transmitting the data to an updateable data file for the at least one widget, the updateable data file comprising information relating to how the widget is displayed; interpreting data transmitted to and from the at least one of the disparate applications, the interpreting step further comprising the steps of building a query with the data input that is intended for the at least one of the disparate applications and querying the at least one of the disparate applications for data to be reported via the display organization; parsing data that is intended to be reported and transmitting the parsed data to the updatable data file for the at least one widget; and communicating data to and from the at last one of the disparate applications and the interpreter in a format that is understood by the at least one of the disparate applications and the interpreter.

The method further comprises the steps of: accepting a data query; parsing the data query to determine a query type; extracting data from the data file for the at least one widget if the query type is a “get” data; transmitting the query to an interpreter module that performs the interpreting step if the query type is selected from the group consisting of an “insert”, “update”, or “delete” data; and locating the at least one widget and preparing the at least one widget to be appended with data from the interpreter module.

The method further comprises the steps of: the interpreter module accepting a return data query from the disparate applications; the interpreter module determining a return data query type; transmitting the data to the a display organizer module for presenting a view of the data if the return query type is a “get” data; and appending the at least one widget of the return query type is selected from the group consisting of an “insert”, “update”, or “delete” data.

A method for providing a graphical user interface that enables sending data to and viewing data from disparate applications via the graphical user interface is provided, the method comprising the steps of: presenting a view of at least one widget, the at least one widget being capable of displaying data from at least one of the disparate applications and data input that is intended for the at least one of the disparate applications, and wherein the at least one widget is user specific; filling the at least one widget with the data input and parsing the data; and extracting data from the at least one widget and parsing the data from the at least one widget; and interpreting data transmitted to and from the at least one of the disparate applications, the interpreting step further comprising the steps of building a query with the data input that is intended for the at least one of the disparate applications and querying the at least one of the disparate applications for data to be reported via the display organization.

A computer readable media for providing a graphical user interface is provided that enables sending data to and viewing data from disparate applications via the graphical user interface, the computer readable media being capable of instructing a computer to: present a view of at least one widget, the at least one widget being configured to display data from at least one of the disparate applications and accept data input that is intended for the at least one of the disparate applications; parse data input and transmit the data to an updateable data file for the at least one widget, the updateable data file comprising information relating to how the widget is displayed; interpret data transmitted to and from the at least one of the disparate applications by building a query with the data input that is intended for the at least one of the disparate applications and querying the at least one of the disparate applications for data to be reported via the display organization; parse data that is intended to be reported and transmit the parsed data to the updatable data file for the at least one widget; and communicate data to and from the at least one of the disparate applications and the interpreter in a format that is understood by the at least one of the disparate applications and the interpreter.

### BRIEF DESCRIPTION OF THE FIGURES

FIG. 1 is a block diagram of a system according to an aspect of the embodiment of the present invention.

FIG. 2 is a flowchart of a method of processing data according to an aspect of an embodiment of the present invention.

FIG. 3 is a flowchart of a method of processing data according to an aspect of an embodiment of the present invention.

### DETAILED DESCRIPTION OF THE INVENTION

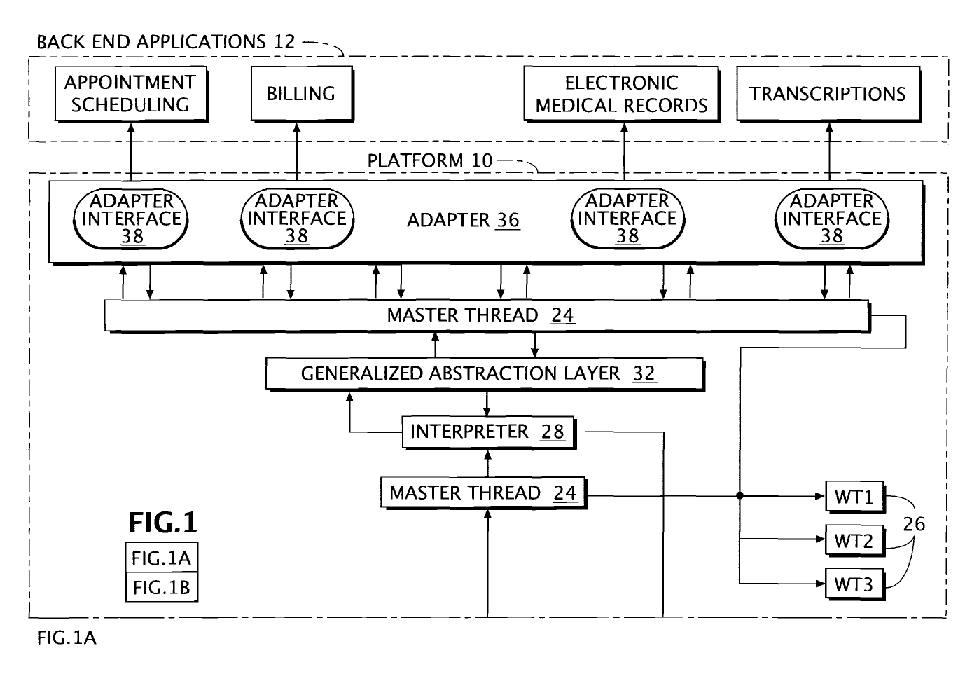

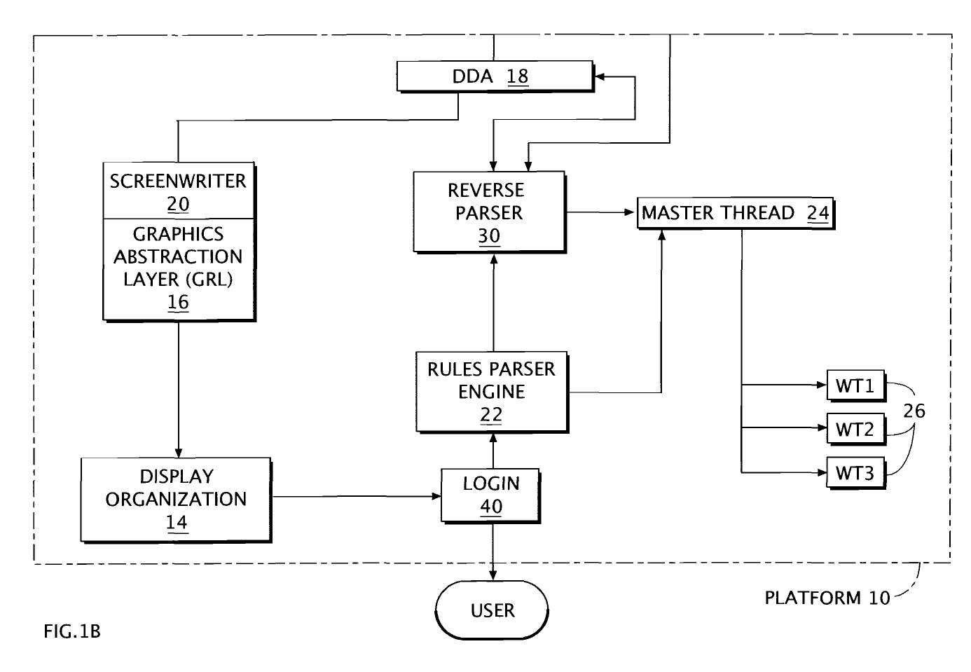

A system according to an aspect of an embodiment of the present invention comprises a software platform that enables communication with disparate applications, such as multiple layers of software, with an intuitive, user-friendly interface. The system is based on a concept of information views that are effectively presented to a user of the system while keeping the background processes transparent to the user. As shown in FIG. 1, a platform 10 according to an aspect of an embodiment may include multiple inter-connected modules, as described in further detail below. The platform 10 may be organized and hosted on a server and the services, background processes, and Back-end Applications 12 may run on a server or multiple servers.

Display Organization (14)

A Display Organization 14 module according to an aspect of an embodiment may be organized in the form of widgets forming a collage of information, referred to herein as the dashboard. The dashboard may be organized as a canvas, and the independent set of information may be set up as widgets. In other words, the dashboard may be what the user views on a computer screen. An underlying database or file for the widgets on the dashboard, such as the Data Display Array (DDA) 18, described below, may contain information necessary for transmission and recreation of the dashboard and the widgets on it for the particular user who is logged on, such as parameter information. Parameter information may include data layout parameters, dashboard dimensions, user profile parameters, print parameters, and other global information about the user and/or company. Each widget may have a context, and the canvas may enable arbitrary content to be drawn within the user's HTML content. Once a handle on the canvas is acquired and the context is obtained, operations intended for the canvas may be called for the context in question.

The platform 10 of the present invention enables the user to park a combination of widgets on the dashboard in a particular pattern, define a method in which the data within each widget on the dashboard is displayed, and link the data elements within those widgets.

A skin area of the widgets may be translucent. This enables the non-data area of the widgets to provide another view to the users so that the user becomes aware of the additional information that is behind the active area of the active widget. Also, the widgets may be resized according to the most relevant and pertinent view of the information while at the same time overlapping a part of the information that gets presented to the user by the other widgets parked on the dashboard. When the widgets are linked, one click on the primary widget may, for example, enable the user to change the content in the other widgets to provide relevance and pertinence. Also, the widgets on the dashboard may provide the user with the ability to add more information to the relevance and pertinence of that part of the dashboard view by morphing widgets into updateable widgets from their display states.

An implementation of the widgets on the dashboard, as described above, may behave similarly to a human memory. When the user logs on to the platform 10 and accesses a set of widgets that provide her with a view of functionalities, when the user then logs out of the platform 10, the platform 10 may “remember” or store in memory the view that the user had when it logged out of the platform 10. This enables the user to continue its train of work and thought process for the next session. Similarly, the platform 10 may provide intelligent access to the widgets from the toolbars and the sub-toolbars. For example, the platform 10 may “learn” from the users' access to particular views of the dashboard constituted by a group of widgets and remember that view so that it can intelligently present the user access to tools on the toolbar.

Login Module (40)

As referenced above, creation of a dashboard and widgets may be specific to the user who is logged onto the platform 10. In order to ensure the validity of the user, when the user logs in, a Login Module 40 may validate the username and password of the user to make sure it is valid. Upon successful validation of the user, the profile for that user may be retrieved, and the dashboard area may be allocated in memory for that user. The allocation of such memory may be user specific so that the user will see the dashboard and the widgets specific for its view.

In one aspect of an embodiment of the present invention, the platform 10 may protect user passwords to enhance the security of the system. Particularly, the Login Module 40 may utilize a two level hierarchy for storing the passwords such that the username and the path of file where the password is stored may be kept in one file (password file), and the encrypted password may be stored in another file (shadow file). This enables the username and password to be stored in an encrypted way and enables the encryption keys/hash value used to store the encrypted password to be changed after some random events. This randomness may provide added security to the user login mechanism.

For example, a user may be assigned a username and password from a system administrator. When a password is created for that user for the first time, a machine generated random password may be created, and the user may be electronically provided with the password electronically and asked to change it at the point of first login.

The user password may be stored in a shadow file using an encryption algorithm that gives the hash value that contains alphanumeric characters and a few characters that are not readable by humans. Instead of storing the plain text of the password, the hash values (some non-human readable values equivalent to password) may be stored in the shadow file. In order to provide additional security, the value to be stored in the shadow file may include a combination of a user's hashed/encrypted password, and a random number. This additional security mechanism may compensate for two or more users having the same password. Additionally, the user's username may be stored in the shadow file with the encrypted string.

Graphics Abstraction Layer (GRL) (16)

A Graphics Abstraction Layer (GRL) 16 according to an aspect of an embodiment may contain information and components that present the user the view and functionality of the Display Organization 14, described above. The GRL 16 may present for use components that constitute the graphics elements of the widgets and the dashboard as a whole and may provide control elements that the user may call into action for a specific task.

Data Display Array (DDA)(18)

A Data Display Array (DDA) 18, mentioned above, according to an aspect of an embodiment, may be an underlying data file that unifies a user and a transaction view of data, and forms a part of a dashboard presentation for a given user at a given time. The DDA may be an XML based file to facilitate ease in adding and removing any data elements if necessary. Each user may be allocated a separate dashboard area in memory at login time based on the user's profile. The DDA 18 may consist of XML tags depending on the data, and hierarchy in the data may be handled via standard XML tag representations. The DDA is a representation of how data is displayed in the widgets on the dashboard canvas.

Screenwriter (20)

A Screenwriter 20, according to an aspect of an embodiment, may get a handle of the “client work space,” which may be the canvas or the dashboard area. The canvas may be identified for most commonly used browsers such as Internet Explorer, Netscape, Mozilla, Firefox et cetera. The widgets that go on the canvas may be based on a user's profile and created on the first pass after the user logs on. Widgets are carriers of data and each widget may have its context, as mentioned above. After acquiring the handle to the canvas, the context may be obtained such that operations intended for the canvas may be called for the context under question. Several processes may be involved in building a screen, such as: remembering a current view profile by saving the context in the DDA 18; emptying the canvas; realizing canvas and widgets with data; and assigning designated colors to the above objects and effects to the canvas.

It is understood that aspects such as canvas dimensions, widget existence, alignment, and positioning may be addressed in the DDA 18 prior to screenwriting by the Screenwriter 20. In other words, the Screenwriter's 20 screenwriting routine may be a straight realization of what is in the DDA 18 without any interpretations or calculations. In such case, the screenwriting routine may report only what is in the DDA 18 so that it does not have to process calculations, input, validations, et cetera.

Rules Parser Engine (22)

While the Screenwriter 18 may send data out towards the user, input from the user may come in the form of flipping the widgets and inputting the data. The widgets may define the various forms of input that are desirable to provide user control and fine tuning such as dropdown bars, voice activation, et cetera. When a user inputs data, it may go through a validation process to determine whether there are any identifiable errors. A simple example is a numeric check. After successful validation, an input may be handed over to a Rules Parser Engine 22 that may be user specific. The Rules Parser Engine 22 may be a parent class that has the generic functionality for all kinds of parsing. Based on the user profile at logon time, an inherited version of the Rule Parser Engine 22 may be instantiated in memory for that user. For example, when a platform 10 is used in a healthcare setting, if the Physician is logged in then the Physician Rules Parser (PRP) may be instantiated in memory. Similarly at a later point when a Medical Clerk logs in then the Clerk Rules Parser (CRP) may be instantiated in memory. Both CRP and PRP may be inherited from the Rules Parser Engine 22 and there may be an instance of Rules Parser Engine 22 also being in memory for a company. This can facilitate localization of any data rules specific to the user. Because the data view may be dependent on the user e.g., the Physician's canvas may be different from the Clerk's, it may not be not necessary to check all the rules for everyone. This child instantiation of the parent Rules Parser Engine may share the commonality of the Rules Parser Engine while at the same time encapsulating the specific rules that apply to the data that can possibly come from a given user. Also, users of the same classification may be serviced by one instance of the Rules Parser Engine. For example, referring to the healthcare setting again, all clerks for the same company may be serviced by one instance of the CRP, as may be the physicians.

The Rules Parser Engine 22 may contain the rules that will be checked before the input data is transmitted to the DDA 18. The DDA 18 may have the screen representation of the data. Any changes to such a data may be parsed first and then transmitted to the DDA 18. When this happens, the DDA 18 modification may get posted to a thread queue, running in the background.

Master Threads (24) and Worker Threads (26)

Master Threads 24 are threads that may run in the background and respond to posted messages in the queue. A Master Thread's 24 job may be to use its intelligence to identify what is the next element in the queue that is to be dispatched to the appropriate process. This intelligence may be based on a company, user, type of message, et cetera. Thus, the Master Thread 24 may not necessarily process the queue in a first in first out (FIFO) fashion. Additionally, the Master Thread 24 may act as a load balancer. For example, when there is an excessive load (which can be parameter driven), the Master Thread 24 may spawn Worker Threads 26 to do the actual job of dispatching. In a no load circumstance, there may be one Master Thread 24 and one Worker Thread 26. In a load situation, there may be multiple Worker Threads 26. This enables threads to run on multiple servers if desired.

There may be two or more sets of Master Threads 24 and respective Worker Threads 26, as shown in the FIG. 1. One set may be for dispatching actions or queries to the Interpreter from DDA 18, and the other set may be between the Interpreter 28 and the outside world of Back-end Applications 12 via the Adapter 36. The posted message content may be in the form of what is getting invoked, an action to be taken, and the request such as whether it is a query request. Additionally, each message token may have some identifier information such as a company.

When the DDA 18 gets modified by the Rules Parser Engine 22, the DDA 17 may post a successful update message to the Master Thread 24 for the Interpreter 28.

Interpreter and Reverse Parser (30)

An Interpreter 28 according to an aspect of an embodiment may be like a gatekeeper from the platform 10 to the outside applications, such as the Back-end Applications 12. The Interpreter may build the query with the input from the user to the appropriate Back-end Application 12. Additionally, the Interpreter may query the Back-end Applications 12 for the appropriate data to be reported in the DDA 18 for the Screenwriter 20 when the Back-end Application 12 reports that a change occurred.

The Interpreter 28 may be in communication with a Reverse Parser 30 which, in accordance with an embodiment of an invention, may reverse parse data coming in from the Back-end Applications 12 to be put back in the DDA 18. Similar to the Interpreter being a gatekeeper to the outside world, the Reverse Parser 30 may be a point of contact of putting the data into the DDA 18 from the outside world. The Reverse Parser 30 may provide intelligence including:
Data Oriented Intelligence—e.g., Minimizing data duplication; Recognizing what data has changed, who changed the data, how the data was changed, and the order in which the data was changed; and Providing intelligent FIND operations across data not just within widgets;
Screen Oriented Intelligence—e.g., Populating role and user specific data; Signaling the appropriate refresh of user/widget to a Screenwriter 20; Recognizing how each piece of data is linked across widgets; Enabling a Screenwriter 20 to be decoupled from the Back-end Applications 12; and Linking the results of FIND operations as described above to positions in the Screenwriter 20.

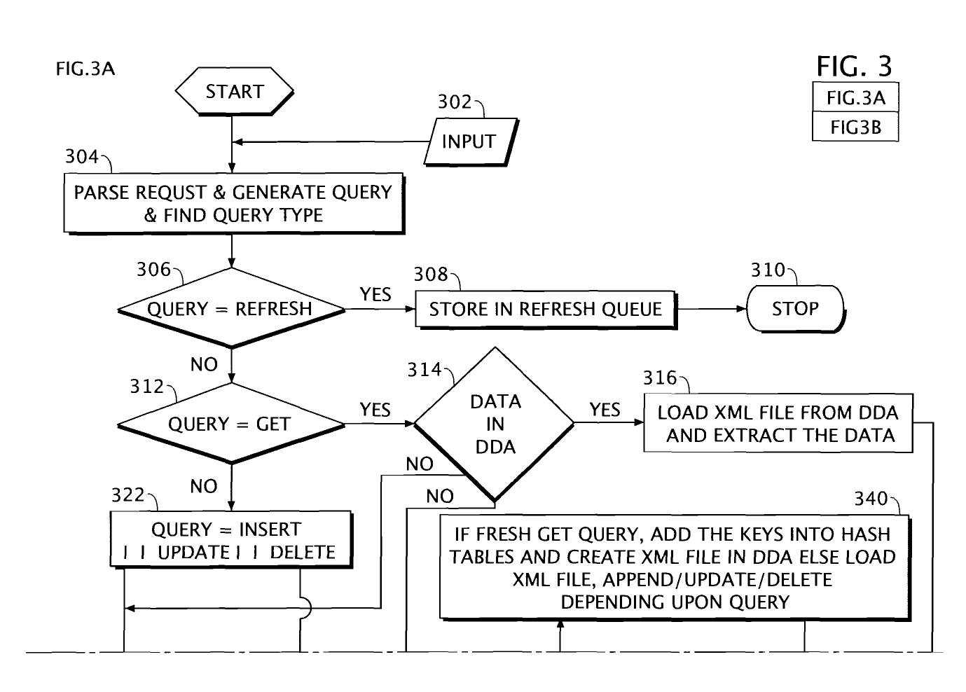

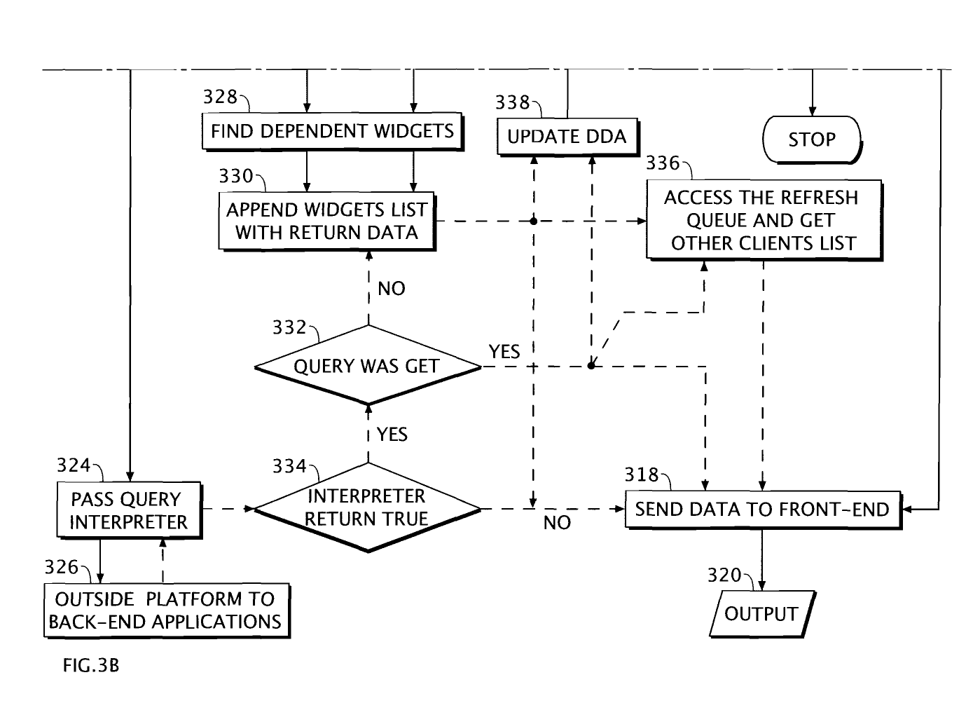

As shown in FIG. 3, when the Reverse Parser 30 accepts a request (input) coming in from the front-end Display Organization 14 (302), it may parse the request to generate a query and find a query type (304). If the query is to refresh the data in the DDA 18 (306), then the query may be stored in the refresh queue (308) and the process ends (310). If, for example, the query type is “get” data (312), which is in the DDA 18 (314), then data may be extracted from the DDA 18 (316), sent to the front-end (318), and output via the Screenwriter and Display Organization 14 (320). If the data is not in the DDA 18 (314) or the query type in step (312) is not a “get” but an insert, update, or delete, then the query may be passed to the Interpreter 28 (324) and sent outside the platform 10 (326) to the Back-end applications 12. At the same time asynchronously, a dependent widgets list may be prepared (328) and kept ready to be appended on the return from the Interpreter 28. The dashed arrow lines show the flow of the return from the Back-end applications 12 to the Interpreter 28 (326, 324). The Interpreter 28, on a successful return, may check first for the query type (334). For a “get” query type (332) the output may be sent to the front-end (318) and output via the Screenwriter 20 and Display Organization 14 (320). On the other hand, if a query type is “insert,” “update,” or “delete,” the widget list may be appended along with the output (330) and sent to the front-end (318), and output via the Screenwriter 20 and Display Organization 14 (320). Additionally, in both of these cases, the Reverse Parser 30 (338, 340) may synchronize dependent widgets with the updated data and send asynchronously messages to the Screenwriter 20 to access the refresh queue to get other client lists and refresh the output on their widgets (336). On an unsuccessful return, the Interpreter 28 may send a message to the front-end which is output via the Screenwriter 20 and Display Organization 14 to report the message.

Referring again to FIG. 1, the Interpreter 28 may be invoked by the Master Thread 24 via Worker Threads 26. The Reverse Parser 30 may post messages for the Interpreter 28 after updating the DDA 18 with the input. The Interpreter 28 may determine from the DDA 18 what changes have been made and build a message specifying the Back-end Application 12, what kind of operation is to be done such as update, delete, add, etc., and the type of request whether it is a push or a query, et cetera. The Interpreter 28 may post this message for the outgoing Master Thread 24 queue. The Master Thread 24 may pick this message up and then pass it along to the Worker Threads 26 to be sent to the appropriate Back-end Application 12 for processing. At this point, the input from the user may successfully end up with the Back-end Application 12 outside the platform 10.

Generalized Abstraction Layer (GAL) (32)

A Generalized Abstraction Layer (GAL) 32 according to an aspect of an embodiment may integrate an Adapter 36 and the Back-end Applications 12 into the platform 10. Specifically, the GAL 32 may enable communication with the Adapter 36 that in turn connects with the Back-end Applications 12. This may enable the platform to be independent of the Back-end Applications 12.

Back-End Applications (12)

Back-end Applications 12 according to an aspect of an embodiment are transaction processing applications outside the platform 10. For example, in the healthcare setting, these could be applications such as Appointment Scheduling, Electronic Medical Records, Billing, Charge Capture, Claim Submission, Transaction Posting, Transcriptions, et cetera. The Back-end Applications 12 may be automated applications or manual applications. The platform 10 may not be concerned with how input from the user is handled in the back-end. The platform 10 may be capable of handing-off a valid input from the user to the back-end via a posted message from the Master Thread 24 protocol. If it is an automated Back-end Application 12, then the Master Thread 24 may notify the Back-end Application 12 passing the information along. Messaging may be done in an XML format so that it may be easily understood and implemented by any application. If, on the other hand, the Back-end Application 12 is manual, then the Master Thread 24 may send a notification by placing the message in a queue for a person to look into and handle. In general, the platform 10 may not have to be dependent on the Back-end Application 12 in any form (automated or manual) or state (whether running or not). Likewise, the Back-end Applications 12 may not be concerned with the platform 10 regarding any updates. Specifically, any updates from some other sources may be independently processed by the Back-end Application 12, and any update notifications may be sent back to the platform 10 to be picked up by the Master Thread 24. When a Back-end Application 12 completes its update or operation, it may post a notification message in the queue. The Master Thread 24 may pick up that message and spawn the Worker Threads 26 to pass it along to the Interpreter 28 with a notification stating that the back-end operation is complete. This operation may be something that the Interpreter 28 requested or something that happened independent of the platform 10. The Interpreter 28, on such a notification, may build a query message to fetch data from the Back-end Applications 12 for the appropriate user profile and post that message back in the Master Thread 24 queue. This time, the Master Thread 24 may invoke the Back-end Applications 12 to get the data. The Back-end Application 12 may respond to the query with the data once again posting that in the Master Thread 24 queue. The Master Thread 24 may invoke the Reverse Parser 30 because this is data coming in and may have to be placed into the DDA 18. The Reverse Parser 30 may format the data to the specification of the DDA 18 and send a message to the Screenwriter 20 to re-populate the screen. The Screenwriter 20 may act on the message and refresh the screen based on the data in the DDA 18.

Adapter

An Adapter 36 according to an aspect of an embodiment may be the gatekeeper to the Back-end Applications 12. The transfer and communication of information across the platform 10 to the Back-end Applications 12 and vice versa may occur via the Adapter 36. The Adapter 36 may communicate in a protocol language that is understood by both the platform 10 and the Back-end Applications 12. The Adapter 36 may, as a result, shield the platform 10 from any disturbances that happen in the back-end arena. These disturbances may be in the form of change of applications, switchover of applications from manual to automated, internal changes within the Back-end Applications 12 e.g., enhancements, feature additions, and process re-engineering, and a host of other things that could alter how the Back-end Applications 12 operate. By the same token, the Back-end Applications 12 may not be dependent on how data is presented or gathered from the screens.

The Adapter 36 may communicate using a language that may package the information going to or coming from the platform 10. The language may be action based such as “get”, “put”, “delete” etc., and the Back-end Applications 12 may respond to this using the same protocol. In order for this to occur, the Back-end Applications 12 may have an Adapter Interface 38 which may take the information coming in and process the appropriate action of “getting” or “putting” the information into its structure. The Adapter Interfaces 38 may also respond back to the Adapter 36 with the requested information in the Adapter 36 language to complete the request.

It may be desirable for the Adapter Interfaces 38 to know the specifics of the respective Back-end Applications 12 and hence may be created by the owners of the individual Back-end Applications 12. For a manual Back-end Application 12, the respective Adapter Interface 38 could package the information into a display form and put it in someone's queue for them to take action on. On the return, it can take a similar action of gathering the information entered and sending it back into the format understood by the Adapter 36.

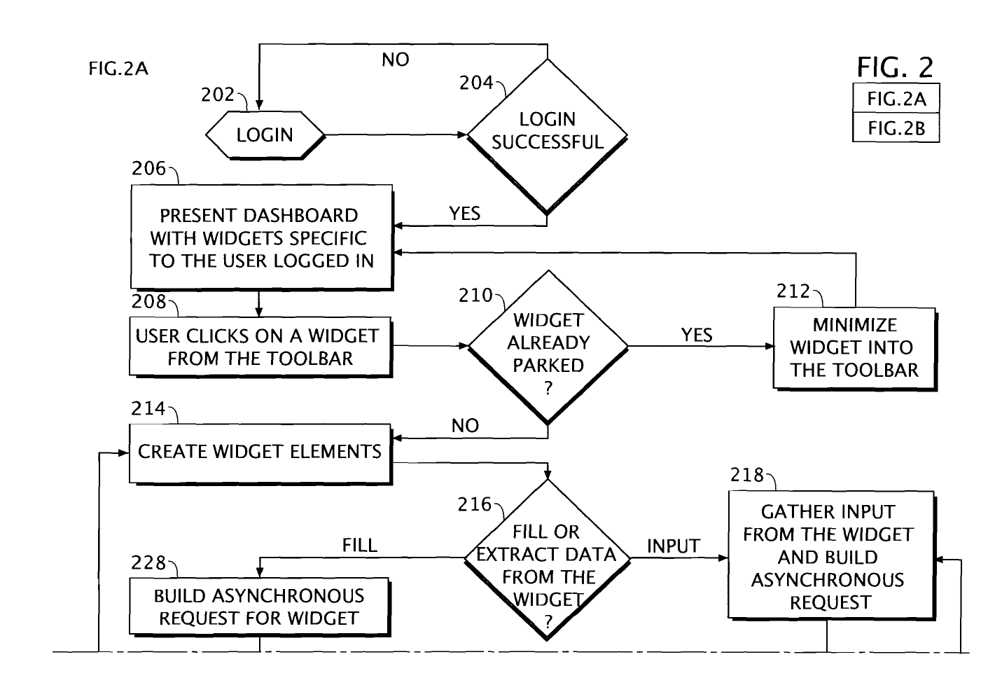

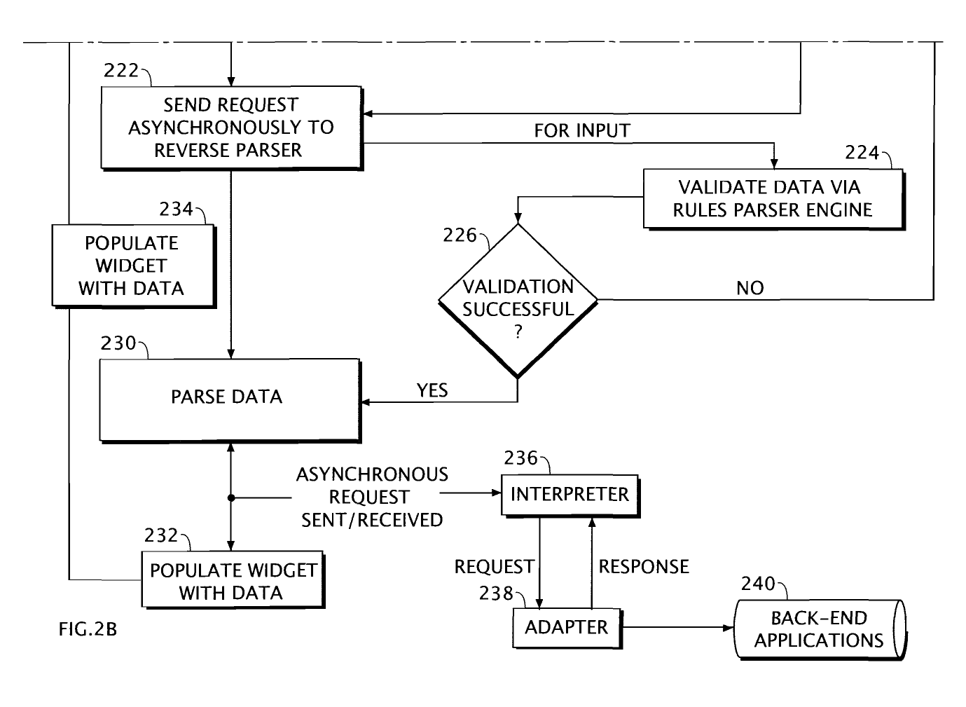

An exemplary flow of data through the foregoing modules of the platform 10 is shown in FIG. 2, wherein a user logs into the system (202). If the Login Module 40 determines that login is successful (204), then the Display Organization 14 may present the user with user-specific widgets (206). The user may click on a widget from the toolbar in the Display Organization 14 (208). If the widget is already parked on the dashboard (210), then the widget may be minimized into the toolbar. (212). If the widget is not already parked on the dashboard (210), then the Graphics Abstraction Layer (GRL 16) may create the needed widget elements (214). If the widget is to be filled with data (216), then the GRL 16 may build an asynchronous request for the widget (228) and the request may be sent to the Reverse Parser 30 (222). If, on the other hand, the data is input from the widget (216), then the GRL 16 may gather such input and build it into the asynchronous request (218), which may be sent to the Reverse Parser 30 (222). When data is input from the widget, the Rules Parser Engine 22 may run a validation check on the data (226) and determine whether the validation is successful (226). If the validation is not successful (226), then the input from the widget may be re-gathered and built into a request (218). The Reverse Parser (30) may parse the data (230), and the Screenwriter 20 may service the request (232) to populate the widget with data (234). Requests that are sent and received may flow through the Interpreter 28 (236), Adapter 36 (238), and Back-end Applications 12 (240).

In view of the foregoing, the present invention provides a system including an integration platform 10 that may present information from disparate Back-end Applications 12 to the user in the form of widgets. The platform 10 may be agnostic to the Back-end Applications 12 and how the data in the Back-end Applications 12 is processed, stored, and retrieved. The platform 10 may be able to provide information that is palatable and pertinent to the user in whatever form, content, or method he/she desires it. The platform 10 thus may enable the technology to become transparent and enable the user to perform his or her job by using technology and at the same time focus on what he or she is actually doing from a user's point of view.

What is claimed is:

1. A system for providing a graphical user interface that enables sending data to and viewing data from disparate applications via the graphical user interface comprising:
a display organizer capable of presenting a view of at least one widget, the at least one widget being configured to display data from at least one of the disparate applications and being configured to accept data input that is intended for the at least one of the disparate applications;
a data display array that is an updatable data file for the at least one widget and comprises parameter information relating to how the at least one widget is displayed via the display organizer;
a rules parser engine comprising rules for parsing the data input via the display organizer, the rules parser engine being capable of transmitting parsed data to the data display array;
an interpreter that is capable of:
building a query with the data input that is intended for the at least one of the disparate applications; and
querying the at least one of the disparate applications for data to be reported via the display organizer;
a reverse parser comprising rules for parsing data from the interpreter that is intended to be reported and transmitting the parsed data to the data display array; and
an adapter that is capable of communicating data to and from the at least one of the disparate applications and the interpreter in a format that is understood by the at least one of the disparate applications and the interpreter.

2. The system of claim 1 wherein the at least one of the disparate applications is a software application or a manual application.

3. The system of claim 1 wherein the parameter information in the data display array further relates to information selected from the group consisting of user identity information, user display preferences information, and printing properties information.

4. The system of claim of claim 1 wherein data in a first at least one widget is capable of being linked to data in a second at least one widget such that a change to the data in the first at least one widget may effect a change of the data in the second at least one widget.

5. The system of claim 1 further comprising a login module that is capable of validating a user identity by:
storing in a first file a username and a path file name indicating where the user's password is stored; and
storing in a second file an encrypted version of the user's password;
wherein a hash value associated with the encrypted version of the user's password may be changed on a random or periodic basis.

6. The system of claim 1 further comprising a screenwriter module that is capable of reading data from the data display array relating to the view that is presented and transmitting the data to the display organizer.

7. The system of claim 6 wherein the data that the screenwriter module transmits to the data display array includes information about the at least one widget selected from the group consisting of widget existence, widget alignment, and widget colors.

8. The system of claim 1 wherein the rules in the rules parser engine are specific to a single user or a group of users.

9. The system of claim 1 further comprising at least one master thread that is capable of determining a transaction processing order for data that is transmitted from the data display array to the interpreter, the master thread determining such transaction processing order based on information selected from the group consisting of the user identity and the type of action to be taken regarding the data.

10. The system of claim 6 further comprising worker threads capable of determining the transaction processing order for the master thread.

11. The system of claim 1 wherein the rules in the reverse parser provide intelligence to parse data, the intelligence being selected from the group consisting of data oriented intelligence and screen oriented intelligence.

12. The system of claim 10 wherein the master thread is capable of posting a query to the at least one of the disparate applications and transmitting a response to the query from the at least one of the disparate applications to the interpreter.

13. The system of claim 1 wherein the adapter further comprises an adapter interface for the at least one of the disparate applications, the adapter interface being capable of packaging data in the format that is understood by the at least one of the disparate applications and the interpreter.

14. The system of claim 1 wherein the at least one widget is configured to display data from multiple ones of the disparate applications and accept data input that is intended for multiple ones the disparate applications.

15. A method for providing a graphical user interface that enables sending data to and viewing data from disparate applications via the graphical user interface, the method comprising the steps of:
presenting a view of at least one widget, the at least one widget being configured to display data from at least one of the disparate applications and accept data input that is intended for the at least one of the disparate applications;
parsing data input and transmitting the data to an updateable data file for the at least one widget, the updateable data file comprising information relating to how the widget is displayed;
interpreting data transmitted to and from the at least one of the disparate applications, the interpreting step further comprising the steps of:
building a query with the data input that is intended for the at least one of the disparate applications; and
querying the at least one of the disparate applications for data to be reported via the display organization;
parsing data that is intended to be reported and transmitting the parsed data to the updatable data file for the at least one widget; and
communicating data to and from the at least one of the disparate applications and the interpreter in a format that is understood by the at least one of the disparate applications and the interpreter.

16. The method of claim 15 further comprising the steps of:
accepting a data query;
parsing the data query to determine a query type;
extracting data from the data file for the at least one widget if the query type is a “get” data;
transmitting the query to an interpreter module that performs the interpreting step if the query type is selected from the group consisting of an “insert”, “update”, or “delete” data; and
locating the at least one widget and preparing the at least one widget to be appended with data from the interpreter module.

17. The method of claim 16 further comprising the steps of:
the interpreter module accepting a return data query from the at least one of the disparate applications;
the interpreter module determining a return data query type;
transmitting the data to the a display organizer module for presenting a view of the data if the return query type is a “get” data; and
appending the at least one widget of the return query type is selected from the group consisting of an “insert”, “update”, or “delete” data.

18. A method for providing a graphical user interface that enables sending data to and viewing data from disparate applications via the graphical user interface, the method comprising the steps of:
presenting a view of at least one widget, the at least one widget being capable of displaying data from at least one of the disparate applications and data input that is intended for the at least one of the disparate applications, and wherein the at least one widget is user specific;
filling the at least one widget with the data input and parsing the data;
extracting data from the at least one widget and parsing the data from the at least one widget; and
interpreting data transmitted to and from the at least one of the disparate applications, the interpreting step further comprising the steps of:
building a query with the data input that is intended for the at least one of the disparate applications; and
querying the at least one of the disparate applications for data to be reported via the display organization.

19. A computer readable media for providing a graphical user interface that enables sending data to and viewing data from disparate applications via the graphical user interface, the computer readable media being capable of instructing a computer to:
present a view of at least one widget, the at least one widget being configured to display data from at least one of the disparate applications and accept data input that is intended for the at least one of the disparate applications;
parse data input and transmit the data to an updateable data file for the at least one widget, the updateable data file comprising information relating to how the widget is displayed;
interpret data transmitted to and from the at least one of the disparate applications by:
building a query with the data input that is intended for the at least one of the disparate applications; and
querying the at least one of the disparate applications for data to be reported via the display organization;
parse data that is intended to be reported and transmit the parsed data to the updatable data file for the at least one widget; and
communicate data to and from the at least one of the disparate applications and the interpreter in a format that is understood by the at last one of the disparate applications and the interpreter.
